(19) United States
(12) Patent Application Publication
(10) Pub. No.: US 2008/0120146 A1
(43) Pub. Date: May 22, 2008

(54) Method for emulating student actions in an on-line course registration system

(76) Inventor: Jason Henry Johnson, Tallahassee, FL (US)

Correspondence Address: John Wiley Horton, Attorney;Pennington, Moore, Wilkinson, Bell & Dunbar, P.A., 2nd Floor, 215 S. Monroe St., Tallahassee, FL, 32301, US

(21) Appl. No.: 11/601,138

(22) Filed: Nov. 17, 2006

(51) Int. Cl. G06Q 10/00

(52) U.S. Cl. 705/5

(57) ABSTRACT

A method for emulating student actions in an on-line course registration system. The on-line course registration system is maintained on a first computer. A student implements the inventive method by running software on a second computer. The software running on the second computer collects log in information and desired course registration information from the student. The student then instructs the software to commence searching. The student' client computer then automatically logs into the server and searches an on-line course registration database in order to determine whether a desired course is available. If availability is found, the client computer can then take one or more of several actions previously requested by the student.

### BACKGROUND OF THE INVENTION

1. Field of the Invention

This invention relates to the field of education. More specifically, the invention comprises a method for emulating and automating student actions in an on-line course registration system.

2. Description of the Related Art

The process of registering for academic courses has become increasingly automated in recent years. Person-to-person interactions were initially replaced by touch-tone telephone interactions. Computer-to-computer interactions over the Internet have now become the normal method for course registration.

An educational institution—such as a university—typically maintains an automated course registration system on a server. The server communicates with a database containing student information and course information. Courses are typically identified by course numbers. A particular student is often assigned a user name and a password. The student can use this information to log into the registration system over the Internet. The student employs a “client” computer to communicate with the institution's server in what is typically referred to as a client-server relationship.

The registration system typically allows the student to take several actions, including: (1) surveying the courses; (2) searching for an open seat in one or more courses; and (3) registering for a course when an open seat is found. Some registration systems include additional functions, such as verifying that a particular student has completed all the prerequisites before permitting the student to register in a particular course.

These prior art systems have saved considerable time and expense for students and faculty members. However, certain problems persist. In order to search for an available seat in a desired course, a student must be physically present at his or her computer and be logged into the registration system. A search conducted may reveal that no seas are available in a desired course. The student is then unable to register.

Those familiar with automated registration systems—particularly in the university setting—will know that the process of dropping and adding courses is a fluid one. Many students will register for a second or third choice course, then drop that course when the student's first choice becomes available. Thus, a course that is presently full will not necessarily remain so.

In the present on-line system, a student will often remain by the computer in order to run periodic searches of course availability. Success is often a matter of random chance. A student who searches at the right moment may find an open seat and quickly take it. Such a process is inherently inefficient, as it interferes with normal student work and class schedules. Thus, a system which would emulate the student's actions in interfacing with the institution's server—even when the student is not physically present—would be advantageous.

### BRIEF SUMMARY OF THE INVENTION

The present invention comprises a method for emulating student actions in an on-line course registration system. The on-line course registration system is maintained on a first computer, typically referred to as a “server.” A student implements the inventive method by running software on a second computer, typically referred to as a “client.”. Throughout this disclosure, the educational institution's computer system will be referred to as a “server,” while the student's computer system will be referred to as a “client.” Also throughout this disclosure, the terms “student” and “user” will be employed interchangeably.

The software running on the second computer collects log in information from the student. The student is next prompted to provide information regarding the courses for which he or she wishes to register. Additional search parameters are preferably also collected. A defined search interval is then set.

The student then instructs the software to commence searching. The student' client computer then automatically logs into the server and searches an on-line course registration database in order to determine whether a desired course is available.

If no seat in the desired course is available, then the client computer logs out. It then waits until the defined search interval has passed before repeating the process. Once an available seat is detected, the client computer takes an action previously defined by the student. The directed action can include automatically registering or the course, opening a text window announcing the course's availability on the student's computer, sending an email to a designated address, sending a text message to a cellular device, or sounding an audible message. The student is thereby given the opportunity to take further action.

### BRIEF DESCRIPTION OF THE SEVERAL VIEWS OF THE DRAWINGS

FIG. 1 is a schematic view, showing the communication network between the student computers and the course registration server.

FIG. 2 is a representative depiction of a user interface showing a login screen.

FIG. 3 is a representative depiction of a user interface showing a course input screen.

FIG. 4 is a representative depiction of a user interface showing an options input screen.

FIG. 5 is a representative depiction of a user interface showing a search log display.

FIG. 6 is a flow chart showing the general operation of the proposed invention.

### REFERENCE NUMERALS IN THE DRAWINGS

| | | | |
|---|---|---|---|
| 10 | communication network | 12 | course registration server |
| 14 | student computer | 16 | login screen |
| 18 | username field | 20 | password field |
| 22 | course input screen | 24 | course number field |
| 26 | reference number field | 28 | term field |
| 30 | add watch button | 32 | watch list display |
| 34 | activation field | 36 | initiation button |
| 38 | cancellation button | 40 | options screen |
| 42 | search interval field | 44 | sound field |
| 46 | open window field | 48 | auto cancel field |
| 50 | email trigger field | 52 | email field |
| 54 | phone trigger field | 56 | phone number field |
| 58 | auto register field | 60 | registration information display |
| 62 | account information display | 64 | search log display |
| 66 | collect login step | 68 | collect search parameters step |
| 70 | search execution step | 72 | delay step |
| 74 | requested action step | | |

### DETAILED DESCRIPTION OF THE INVENTION

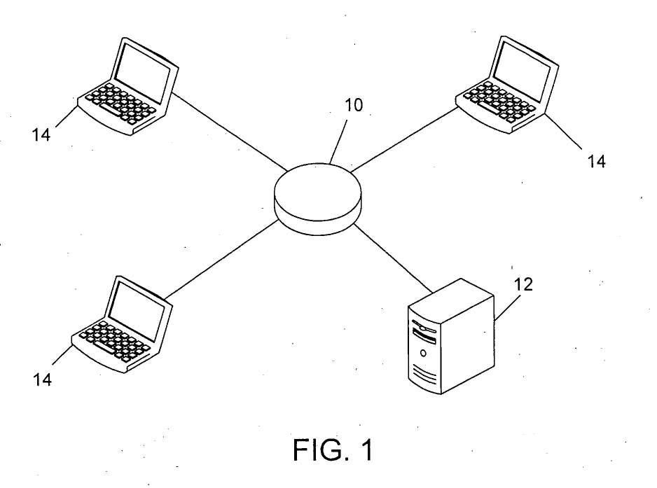

FIG. 1 schematically represents the connection of a plurality of student computers 14 to a course registration server 12 over a communication network 10. Communication network 10 can assume many forms, with the world-wide communication network known as the Internet being the most common. Those skilled in the art will know that many connection types—such as wireless or fiber optic links—can be used as part of the network. The particular communication technology used is not significant to the present invention and it will therefore not be discussed in further detail.

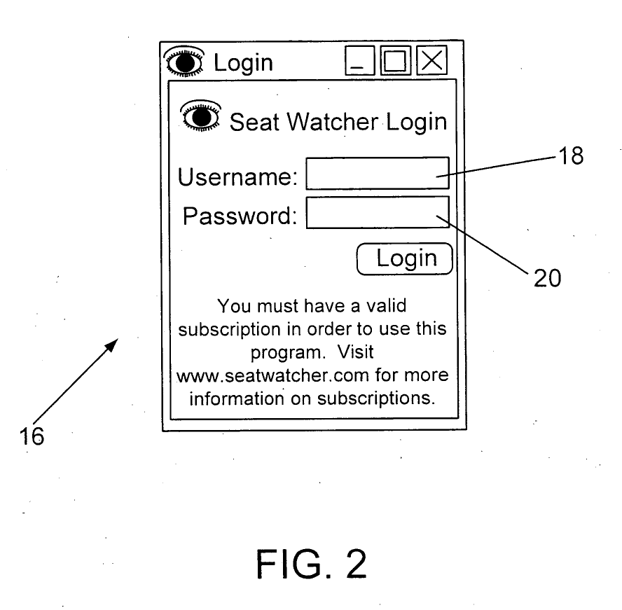

The invention is preferably implemented using software running on the client computer. Many different user interfaces could be provided for the student. FIGS. 2-5 depict one embodiment of such a user interface.

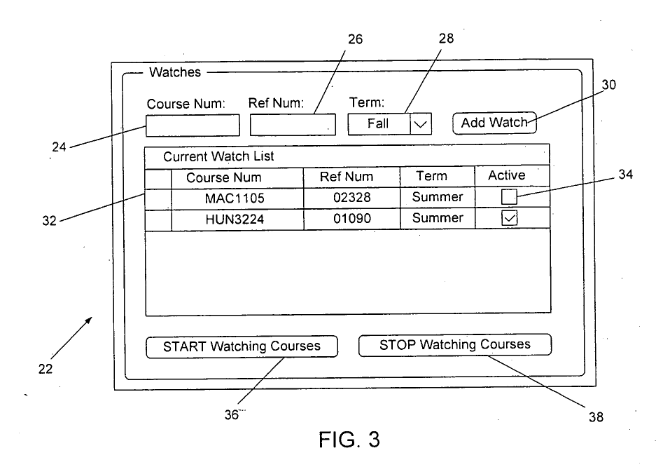

Most on-line registration systems require a student to provide a user name and password in order to gain access to the system. Thus, this information must be obtained. FIG. 2 shows login screen 16. It prompts the student to enter a previously-assigned user name in username field 20. Once these are entered the student presses the “login” button and the user interface preferably displays something like course input screen 22 shown in FIG. 3.

A student may naturally wish to monitor space availability in several courses. Thus, the user interface preferably allows the student to build a “watch list.” To add a course, the student enters the course's number in course number field 24. If a reference number needs to be associated with the course, the student enters this number in reference number field 26.

Term filed 28 allows the student to designate the term (such as spring, summer, or fall). Once the student is satisfied that the information is correct, he or she actuates add watch button 30. The information then appears on watch list display 32.

The user may build a watch list of several courses. The user checks the activation field 34 for a particular course in order to indicate that the course should be searched for availability. When the user activates initiation button 36, the system begins to iteratively search and perform other operations. Before the searching is described in detail, however, various setting options will be explained.

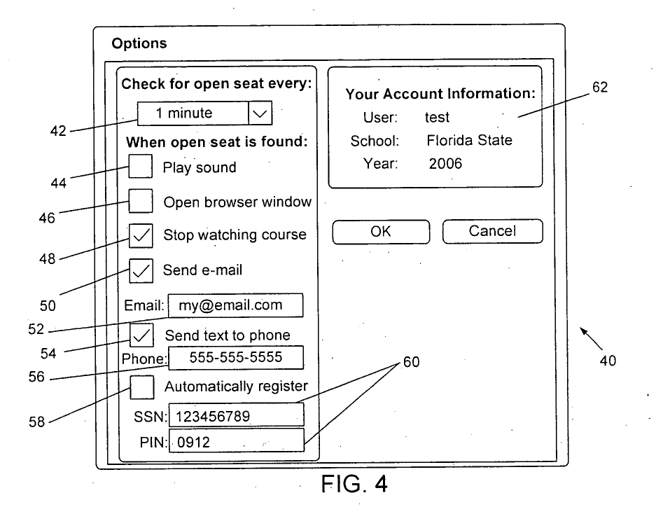

An objective of the present invention is to allow course searching and other actions to be taken while the student is not physically present before the client computer. The student is preferably given options regarding the searching and the actions to be taken. FIG. 4 shows a representative options screen 40.

Once set in motion, the software is designed to search for an available seat in a course until one is found or the search is terminated by the student. However, continuously bombarding the registration system server with search requests could unduly burden the system and ultimately cause a “denial of service” system crash. Thus, the system preferably runs a search at a fixed interval. The student can enter the fixed interval in search interval field 42. The system preferably sets a minimum threshold for the value (such as 1 or 2 minutes). In some embodiments, a fixed value for the time interval can be defined, with the student being given no option to change it.

The student may wish for the software to take different actions when an open seat is found. The user can have his computer play a sound by checking sound field 44. The sound can be a simple tone, a piece of music, a voice message, or the like.

The user may also wish for the software to open a browser window. This could be useful in alerting the student to the existence of an open seat if the student returns to the client computer after having been away.

The user may wish to have the software stop searching a course once an open eat is found. If so, he or she checks auto cancel field 48. Of course, a seat may only remain open for a short period. Thus, a student may return to his or her computer to find that a previously open seat has closed again. It is therefore preferable to provide remote notification means. A student can direct a notice to be sent to an email address by checking email trigger field 50 and providing an email address in email address field 52. If an open seat is detected, the student can then receive detailed information regarding the available course. The system can even be configured to receive remote instructions back from the student (such as an instruction telling the client computer to register the student in the course).

Another convenient notification approach is the use of a text message to a cellular device. The user can set this option by checking phone trigger field 54 and providing a phone number in phone number field 56. The text message can provide detailed course information with a message like “MAC1105-2 OPEN SEATS FOUND.” Again, the system can be configured so that the user can reply with an instruction from the cellular device.

Of course, if the student is certain that he or she wishes to enroll in a particular course, the best action may be to have the software automatically register the student. if so, the student checks auto register field 58. Depending on the registration system in question, the software may need to collect additional information. For example, many universities associate a personal identification number (“PIN”) with a student's social security number. The student must provide both to complete the registration. In such a case, the software would display an additional screen requesting that information. Once the information is entered, the student is returned to course input screen 22 (FIG. 3). When the student then selects initiation button 36, searching begins for these courses on the watch list display that are designated as active. The system can also be configured to allow auto registration to be selected on a course-by-course basis.

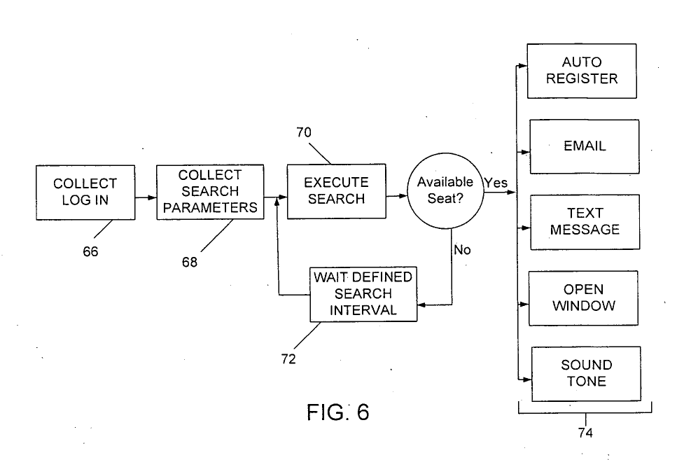

FIG. 6 schematically depicts the iterative search process. Having proceeded through collect log in step 66 and collect search parameters step 68, the student initiates the searching. The student's client computer logs into the server hosting the on-line course registration system. The client computer then runs a search in search execution step 70. If no available seats are found, then the client computer waits through delay step 72 (corresponding to the defined search interval). Search execution step 70 is then repeated. Searches are continued until an available seat is found. At that point, one or more of the requested actions 74 will be taken (depending on how the student configured the options).

Significantly, the repetitive search process continues without any action from the student. The running of the software on the student's client computer is “invisible” to the host server. It simply interprets the communications from the client computer as a “live” student logging into the system and performing normal operations.

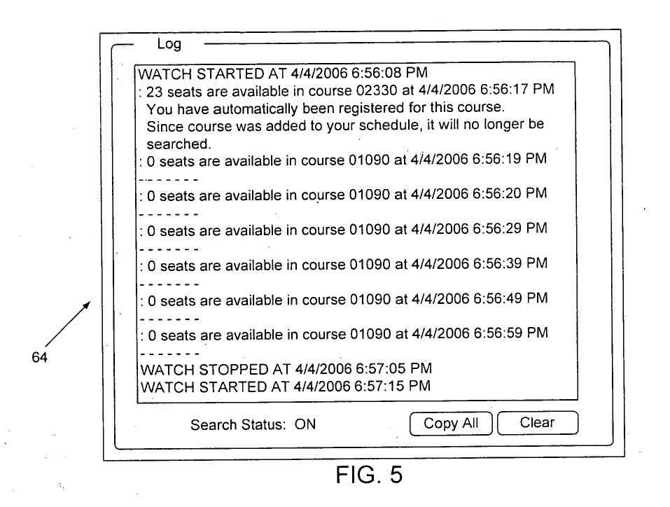

The student may naturally wish to monitor the progress of the search from time to time. A search log is preferably provided for this purpose. FIG. 5 shows a representative search log display 64. The student is able to scroll through the log to observe the results of each search performed, as well as other activities (such as auto registration).

An example of the operation of the software may be helpful to the reader's understanding. Suppose that the student is seeking registration in the following two courses:

| Course Name | Course No. | Ref. No. | Term |
|---|---|---|---|
| Math 211 | MA0211 | 01148 | Summer |
| Math 216 | MA0216 | 10641 | Summer |

In this scenario, the two courses are in competing time slots. The student's first choice is Math 211, but she would be willing to accept Math 216 if it becomes available. The student therefore selects the “auto register” option for Math 211. For Math 216, she does not select “auto register,” instead having the software send a text message to her cell phone in the event a seat is found in that course. She then initiates the searching and leaves to go to other classes.

The system commences searching and finds no open seats in either class. Two hours later, however, a seat opens in Math 216. The student receives a text message informing her of this fact on her cell phone. She has the ability to send a reply text message directing the system to register her in Math 216, but elects to wait in order to see whether her first choice will open.

An hour later she returns to her apartment and pulls up the search log. She notes that during her absence a second open seat appeared in Math 216, but that the second open seat has now been taken. Math 211 remains closed. She then elects to register in the remaining seat in Math 216. She finishes by deactivating the search for Math 211.

Those skilled in the art will realize that additional features can be provided within the framework heretofore described. As one example, a student might wish to search two “competing” courses with the goal of registering in the first one that opens. An additional “options” menu could easily be provided for this purpose. Once a seat has been obtained within one of the courses, the system could be configured to automatically stop searching the other course.

Many other variations could be made while still practicing the inventive method disclosed herein. Accordingly, the scope of the invention should be fixed by the following claims rather than any specific examples provided.

Having described my invention, I claim:

1. A method of emulating actions of a student in an on-line course registration system, wherein said on-line course registration system resides on a first computer system and includes an on-line interface accessible over a communication network when an appropriate username and password is provided, a database containing a plurality of course identifiers each corresponding to a course, indicating means to indicate whether a seat is available for each of said plurality of course identifiers, and registration means allowing said student to register in a desired, comprising:
a. on a second computer system having access to said communication network, collecting login information from said student, including a username and password;
b. on said second computer system, collecting desired course information from said student, including at least one course identifier;
c. establishing a defined search interval;
d. at periodic points in time separated by said defined search interval, transmitting from said second computer system to said first computer system,
i. said username and said password in order to log in said student,
ii. said at least one course identifier in order to search said database on said first computer system in order to determine whether a seat is available in a course corresponding to said at least one course identifier; and
e. upon receiving from said first computer system back to said second computer system an indication that a seat is available in said course corresponding to said at least one course identifier, notifying said student of said availability.

2. A method of emulating actions of a student as recited in claim 1, further comprising allowing said student on said second computer system to set said defined search interval.

3. A method of emulating actions of a student as recited in claim 2, further comprising defining a minimum time interval below which said defined search interval is not allowed to go.

4. A method of emulating actions of a student as recited in claim 1, wherein said step of notifying said student of said availability is accomplished by emailing a message to a predefined email address.

5. A method of emulating actions of a student as recited in claim 1, wherein said step of notifying said student of said availability is accomplished by transmitting a text message to a predefined cellular device.

6. A method of emulating actions of a student as recited in claim 1, wherein said step of notifying said student of said availability is accomplished by opening a window on said second computer system.

7. A method of emulating actions of a student as recited in claim 1, wherein said step of notifying said student of said availability is accomplished by sounding a tone on said second computer system.

8. A method of emulating actions of a student as recited in claim 4, further comprising transmitting a response message from said predefined email address back to said second computer system, wherein said response message instructs said second computer system to take a further action.

9. A method of emulating actions of a student as recited in claim 5, further comprising transmitting a response text message back from said predefined cellular device to said second computer system, wherein said response message instructs said second computer system to take a further action.

10. A method of emulating actions of a student in an on-line course registration system, wherein said on-line course registration system resides on a first computer system and includes an on-line interface accessible over a communication network when an appropriate username and password is provided, a database containing a plurality of course identifiers each corresponding to a course, indicating means to indicate whether a seat is available for each of said plurality of course identifiers, and registration means allowing said student to register in a desired, comprising:
a. on a second computer system having access to said communication network, collecting login information from said student, including a username and password;
b. on said second computer system, collecting desired course information from said student, including at least one course identifier;
c. establishing a defined search interval;
d. at periodic points in time separated by said defined search interval, transmitting from said second computer system to said first computer system,
i. said username and said password in order to log in said student,
ii. said at least one course identifier in order to search said database on said first computer system in order to determine whether a seat is available in a course corresponding to said at least one course identifier; and
e. upon receiving from said first computer system back to said second computer system an indication that a seat is available in said course corresponding to said at least one course identifier, automatically registering said student in said course corresponding to said at least one course identifier.

11. A method of emulating actions of a student as recited in claim 10, further comprising allowing said student on said second computer system to set said defined search interval.

12. A method of emulating actions of a student as recited in claim 11, further comprising defining a minimum time interval below which said defined search interval is not allowed to go.

13. A method of emulating actions of a student as recited in claim 1, further comprising providing a search log recording all searches performed and all results obtained.

14. A method of emulating actions of a student as recited in claim 1, further comprising providing a watch list listing all course identifiers supplied by said student and indicating which of said course identifiers are selected to be searched.

15. A method of emulating actions of a student as recited in claim 10, further comprising providing a search log recording all searches performed and all results obtained.

16. A method of emulating actions of a student as recited in claim 10, further comprising providing a watch list listing all course identifiers supplied by said student and indicating which of said course identifiers are selected to be searched.

17. A method of emulating actions of a student as recited in claim 2, further comprising providing a search log recording all searches performed and all results obtained.

18. A method of emulating actions of a student as recited in claim 4, further comprising providing a search log recording all searches performed, all results obtained, and all email messages sent.

19. A method of emulating actions of a student as recited in claim 5, further comprising providing a search log recording all searches performed, all results obtained, and all text messages sent.

20. A method of emulating actions of a student as recited in claim 4, further comprising providing a search log recording all searches performed, all results obtained, all email messages sent, and all email messages received.
